(19) United States
(12) Patent Application Publication
(10) Pub. No.: US 2007/0287546 A1
(43) Pub. Date: Dec. 13, 2007

(54) Bellows with buckling protector

(76) Inventor: Dietmar Fischer, Kressbronn (DE)

Correspondence Address: Klaus P. Stoffel;Wolff & Samson, One Boland Drive, West Orange, NJ, 07052, US

(21) Appl. No.: 11/810,921

(22) Filed: Jun. 6, 2007

(30) Foreign Application Priority Data
Jun. 10, 2006 (DE) 10 2006 027 048.7

(51) Int. Cl. F16D 3/84

(52) U.S. Cl. 464/173

(57) ABSTRACT

A bellows with a buckling protector for multi-part universal-joint propeller shafts with at least one joint as a connection between the propeller shafts and with a bellows carrier attached to one of the propeller shafts. The buckling protector is integrated into the bellows.

### BACKGROUND OF THE INVENTION

The invention pertains to a bellows with a buckling protector.

JP 2005231466 discloses a bellows for multi-part universal-joint propeller shafts with a homokinetic joint as a connection between component shafts, where the bellows is mounted on a bellows carrier attached to one of the component shafts. The bellows carrier is made of sheet metal. The disadvantage is that, if the bellows carrier buckles, it can come in contact with the bellows, which is made of rubber, as a result of which the bellows can be damaged.

It is also known that a separate component can be mounted as a buckling protector on the bellows carrier. The disadvantage here, however, is that separate components can be forgotten during assembly or can come loose afterwards, which means that, without protection, the bellows is again exposed to the bellows carrier.

### SUMMARY OF THE INVENTION

The task of the invention is to create a bellows with an improved buckling protector.

According to the invention, a bellows with buckling protector for multi-part universal-joint propeller shafts with preferably at least one homokinetic joint as a connection between the propeller shafts is provided, where the bellows is mounted on a bellows carrier, which is fastened to one of the propeller shafts and into which a buckling protector is integrated. The inventive bellows with an integrated rubber buckling protector is reliably protected from any damage which might be caused by the sheet metal bellows carrier itself. The inventive bellows also simplifies assembly and reliably eliminates possible errors during assembly such as forgetting to install the buckling protector, installing the protector incorrectly, etc. The integrated buckling protector is more favorable with respect to production because one component and one assembly step are eliminated.

According to a preferred embodiment of the invention, the buckling protector is integrated during the vulcanizing process, which means that the buckling protector can be produced without any additional effort.

According to another preferred embodiment of the invention, a radially inner sidepiece, integrated during the vulcanizing process, is provided as the buckling protector. This sidepiece extends axially over the connection between the bellows and the bellows carrier.

Exemplary embodiments of the invention are explained below by reference to the attached drawings

### DETAILED DESCRIPTION OF THE INVENTION

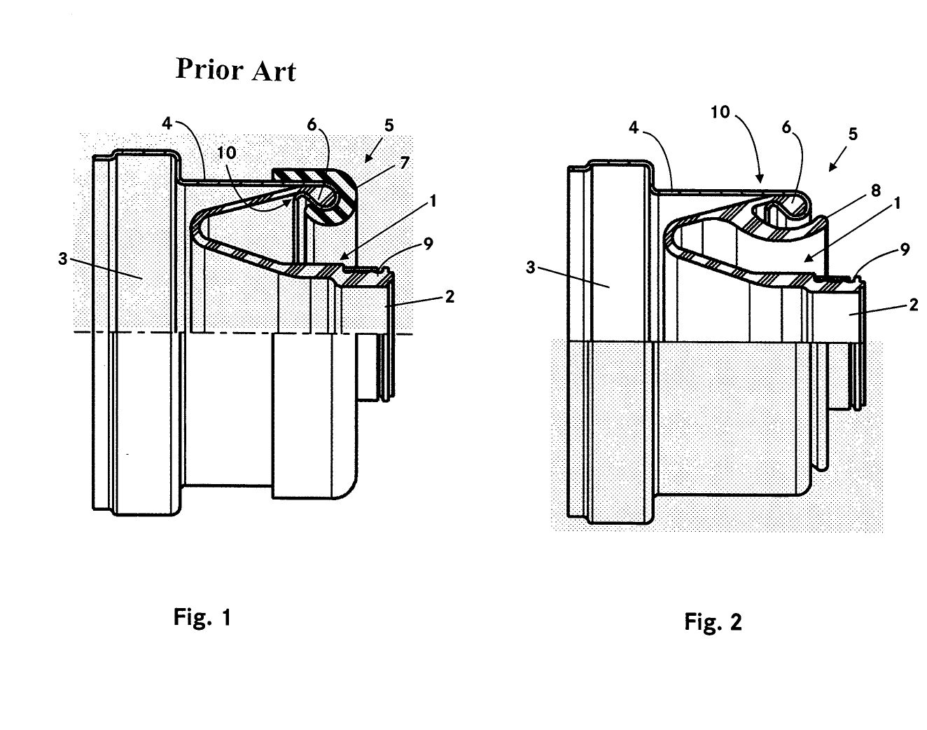

FIG. 1 shows a partially cut-away side view of a bellows with buckling protector between two propeller shafts according to the prior art, and

FIG. 2 shows a partially cut-away side view of a bellows with buckling protector between two propeller shafts according to the invention.

### DETAILED DESCRIPTION OF THE INVENTION

FIG. 1 shows a bellows 1 according to the prior art with a first end 9 mounted on a first propeller shaft 2. A bellows carrier 4 of sheet metal with a diameter larger than that of the first propeller shaft 2 is mounted on a second propeller shaft 3, connected coaxially to the first propeller shaft 2, the carrier 4 extending coaxially toward the first propeller shaft 2. The free circumferential edge 5 of the bellows carrier 4 is provided with an elastic clamping strip 6, which is folded over toward the inside and then back. The second end 10 of the bellows 1 is mounted on the radially inner, free circumferential edge 5 of the bellows carrier 4 under the elastic clamping strip 6 and thus covers the opening between the first propeller shaft 2 and the second propeller shaft 3. A buckling protector 7, representing a separate component, is pushed onto the free circumferential edge 5 of the bellows carrier 4.

FIG. 2 shows a side view of the inventive bellows. Corresponding features are designated by the same reference numbers as those of FIG. 1. The bellows 1 is mounted on the first propeller shaft 2. The bellows carrier 4 of sheet metal with a diameter larger than that of the first propeller shaft 2 is mounted on the second propeller shaft 3, which is connected coaxially to the first propeller shaft 2, and the bellows 1 is mounted on the free circumferential edge 5 of the bellows carrier 4 in the same way as in FIG. 1.

A buckling protector 8 is provided as an integral part of the bellows 1. The buckling protector 8 branches off from the bellows 1 radially toward the inside in front of the free circumferential edge 5 of the bellows carrier 4 and extends with a thumb-like curve over the free circumferential edge 5 of the bellows carrier 4. The buckling protector 8 therefore lies between the free circumferential edge 5 of the bellows carrier 4 and the bellows 1. The buckling protector 8 is integrated into the vulcanizing mold of the bellows 1.

The following advantages of the invention can be derived from the description:

the buckling protector can be produced without any additional effort;

assembly is simplified;

potential assembly errors (forgetting to install the buckling protector, assembling incorrectly) can no longer occur; and

production costs are decreased (elimination of 1 component and 1 assembly step).

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. A bellows, for multi-part universal-joint propeller shafts with at least one joint as a connection between the two propeller shafts and with a bellows carrier attached to one of the propeller shafts, the bellows having a buckling protector integrated into the bellows.

2. The bellows according to claim 1, wherein the buckling protector is integrated by vulcanization.

3. The bellows according to claim 2, wherein a radially inner sidepiece, integrated during vulcanization, is provided as the buckling protector, the sidepiece being arranged to extend axially over the connection between the bellows and the bellows carrier.
